(19) United States
(12) Patent Application Publication
(10) Pub. No.: US 2023/0223074 A1
(43) Pub. Date: Jul. 13, 2023

(54) READOUT CIRCUIT LAYOUT

(71) Applicant: CHANGXIN MEMORY TECHNOLOGIES, INC., Hefei City (CN)

(72) Inventor: Guifen YANG, Hefei City (CN)

(21) Appl. No.: 17/805,991

(22) Filed: Jun. 8, 2022

Related U.S. Application Data
(63) Continuation of application No. PCT/CN2022/078107, filed on Feb. 25, 2022.

(30) Foreign Application Priority Data
Jan. 11, 2022 (CN) 202210028129.8

(51) Int. Cl. G11C 11/4097; G11C 11/4094; G11C 11/4096; G11C 11/4072

(52) U.S. Cl. CPC G11C 11/4097; G11C 11/4072; G11C 11/4094; G11C 11/4096

(57) ABSTRACT

The present disclosure relates to the field of semiconductor circuit design, and in particular, to a readout circuit layout, including: a first PMOS layout, configured to form a first PMOS transistor <P1>, wherein a source of the first PMOS transistor is connected to a first signal terminal, and the first signal terminal is configured to receive a first level signal; a first NMOS layout, configured to form a first NMOS transistor <N1>, wherein a source of the first NMOS transistor is connected to a second signal terminal, and the second signal terminal is configured to receive a second level signal; a gate of the first PMOS transistor <P1> and a gate of the first NMOS transistor <N1> are connected to a bit line, and a drain of the first PMOS transistor <P1> and a drain of the first NMOS transistor <N1> are connected to a complementary readout bit line.

### CROSS-REFERENCE TO RELATED APPLICATIONS

This is a continuation of International Application No. PCT/CN2022/078107, filed on Feb. 25, 2022, which claims the priority to Chinese Patent Application No. 202210028129.8, titled “READOUT CIRCUIT LAYOUT” and filed on Jan. 11, 2022. The entire contents of International Application No. PCT/CN2022/078107 and Chinese Patent Application No. 202210028129.8 are incorporated herein by reference.

### TECHNICAL FIELD

The present disclosure relates to the field of semiconductor circuit design, and in particular, to a readout circuit layout.

### BACKGROUND

A dynamic random access memory (DRAM) writes data through electric charge in a cell capacitor; the cell capacitor is connected to a bit line and a complementary bit line. In the DRAM, when a read operation or a refresh operation is performed, a readout amplifier reads and amplifies a voltage difference between the bit line and the complementary bit line.

The inventors find that a gate of a PMOS of a sense amplifier at present is controlled by a readout bit line/complementary readout bit line, and there is a terminal connected to the readout bit line/complementary readout bit line. After the PMOS is turned on, the potential of the readout bit line/complementary readout bit line may change due to influence of the PMOS, which may affect the accuracy of memory data readout.

### SUMMARY

An embodiment of the present disclosure provides a readout circuit layout, including: a first PMOS layout, configured to form a first PMOS transistor, wherein a source of the first PMOS transistor is connected to a first signal terminal, and the first signal terminal is configured to receive a first level signal; a first NMOS layout, configured to form a first NMOS transistor, wherein a source of the first NMOS transistor is connected to a second signal terminal, and the second signal terminal is configured to receive a second level signal; one of the first level signal and the second level signal is a high level signal, and the other of the first level signal and the second level signal is a low level signal; a gate of the first PMOS transistor and a gate of the first NMOS transistor are connected to a bit line, and a drain of the first PMOS transistor and a drain of the first NMOS transistor are connected to a complementary readout bit line; a second PMOS layout, configured to form a second PMOS transistor, wherein a source of the second PMOS transistor is connected to the first signal terminal; and a second NMOS layout, configured to form a second NMOS transistor, wherein a source of the second NMOS transistor is connected to the second signal terminal; wherein a gate of the second PMOS transistor and a gate of the second NMOS transistor are connected to a complementary bit line, and a drain of the second PMOS transistor and a drain of the second NMOS transistor are connected to a readout bit line; and in a direction perpendicular to an extension direction of the bit line, the first PMOS layout and the second PMOS layout are symmetrical to each other, and the first NMOS layout and the second NMOS layout are symmetrical to each other.

### BRIEF DESCRIPTION OF THE DRAWINGS

One or more embodiments are described illustratively by use of corresponding drawings. The illustrative description does not constitute any limitation on the embodiments. Unless otherwise expressly specified, the drawings do not constitute a scale limitation. To describe the technical solutions in the embodiments of the present disclosure or in the prior art more clearly, the following outlines the drawings to be used in the embodiments of the present disclosure. Evidently, the drawings outlined below are merely some embodiments of the present disclosure. A person of ordinary skill in the art may derive other drawings from the outlined drawings without making any creative effort.

FIG. 1 is a schematic diagram of a circuit structure of a sense amplification circuit according to an embodiment of the present disclosure;

FIG. 2 is a schematic diagram of a circuit structure of a first type of equalizing charge module according to an embodiment of the present disclosure;

FIG. 3 is a schematic diagram of a circuit structure of a second type of equalizing charge module according to an embodiment of the present disclosure;

FIG. 4 is a schematic diagram of a circuit structure of a third type of equalizing charge module according to an embodiment of the present disclosure;

FIG. 5 is a schematic diagram of a circuit structure of a fourth type of equalizing charge module according to an embodiment of the present disclosure;

FIG. 6 is a schematic diagram of a working sequence of a sense amplification circuit according to an embodiment of the present disclosure;

FIG. 7 is a schematic diagram of a first layout corresponding to a circuit having the equalizing charge module shown in FIG. 2 or FIG. 3 according to an embodiment of the present disclosure;

FIG. 8 is a schematic diagram of a second layout corresponding to a circuit having the equalizing charge module shown in FIG. 2 or FIG. 3 according to an embodiment of the present disclosure;

FIG. 9 is a schematic diagram of a third layout corresponding to a circuit having the equalizing charge module shown in FIG. 2 or FIG. 3 according to an embodiment of the present disclosure;

FIG. 10 is a schematic diagram of a fourth layout corresponding to a circuit having the equalizing charge module shown in FIG. 2 or FIG. 3 according to an embodiment of the present disclosure;

FIG. 11 is a schematic diagram of a fifth layout corresponding to a circuit having the equalizing charge module shown in FIG. 2 or FIG. 3 according to an embodiment of the present disclosure;

FIG. 12 is a schematic diagram of a layout in which active regions for receiving a pre-charge signal in the equalizing charge module shown in FIG. 7 to FIG. 11 are connected according to an embodiment of the present disclosure;

FIG. 13 is a schematic diagram of a first layout corresponding to a circuit having the equalizing charge module shown in FIG. 4 or FIG. 5 according to an embodiment of the present disclosure;

FIG. 14 is a schematic diagram of a second layout corresponding to a circuit having the equalizing charge module shown in FIG. 4 or FIG. 5 according to an embodiment of the present disclosure;

FIG. 15 is a schematic diagram of a third layout corresponding to a circuit having the equalizing charge module shown in FIG. 4 or FIG. 5 according to an embodiment of the present disclosure;

FIG. 16 is a sectional structural diagram of another PMOS layout according to an embodiment of the present disclosure.

### DETAILED DESCRIPTION

A gate of a PMOS of a sense amplifier at present is controlled by a readout bit line/complementary readout bit line, and there is a terminal connected to the readout bit line/complementary readout bit line. That is, after the PMOS of the sense amplifier is turned on, the potential of the readout bit line/complementary readout bit line may change due to influence of the PMOS, which may affect the accuracy of memory data readout.

An embodiment of the present disclosure provides a readout circuit layout, to improve the readout accuracy of a sense amplifier.

Those of ordinary skill in the art should understand that many technical details are proposed in the embodiments of the present disclosure to make the present disclosure better understood. However, even without these technical details and various changes and modifications made based on the following embodiments, the technical solutions claimed in the present disclosure may still be realized. The following divisions of the various embodiments are intended for convenience of description, and are not intended to constitute any limitation to the specific implementation of the present disclosure. The various embodiments may be combined with each other in case of no contradiction.

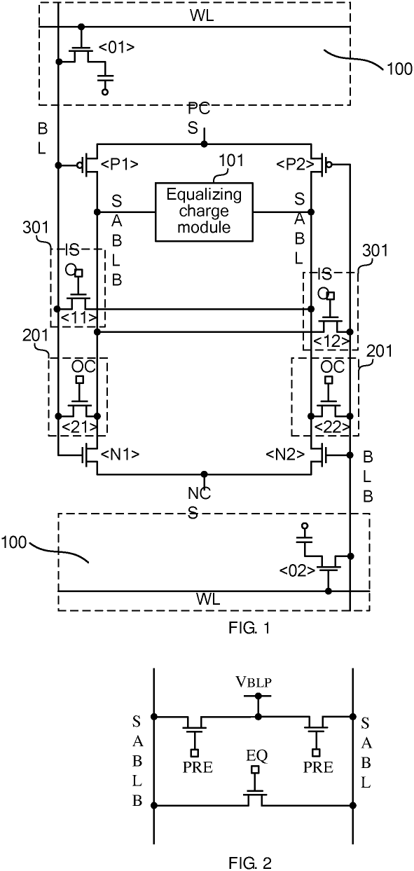

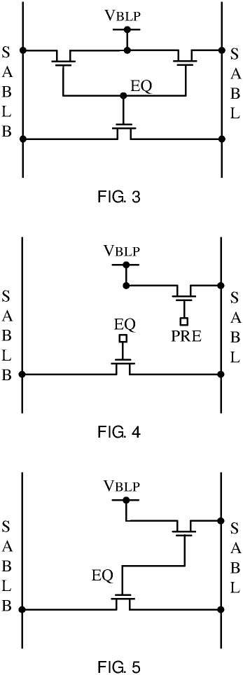

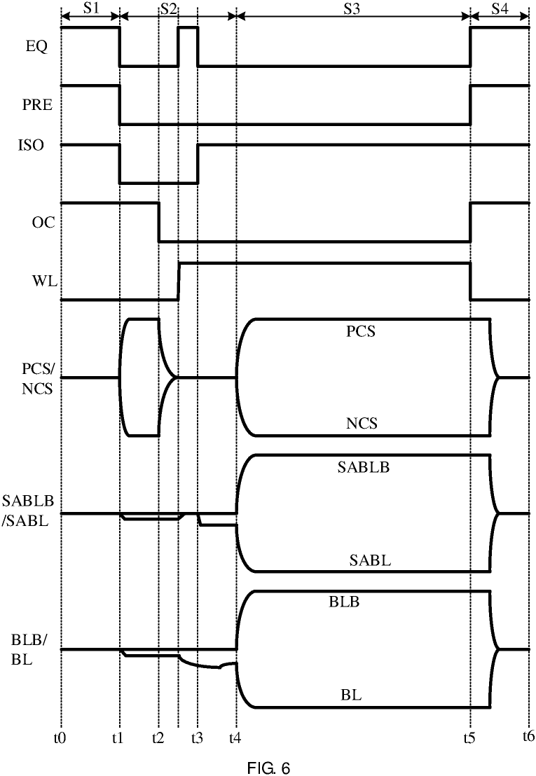

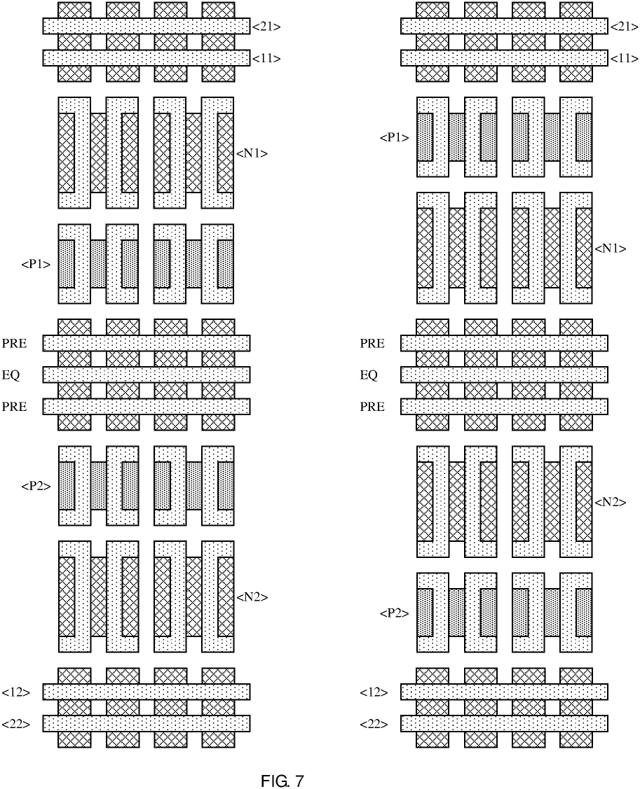

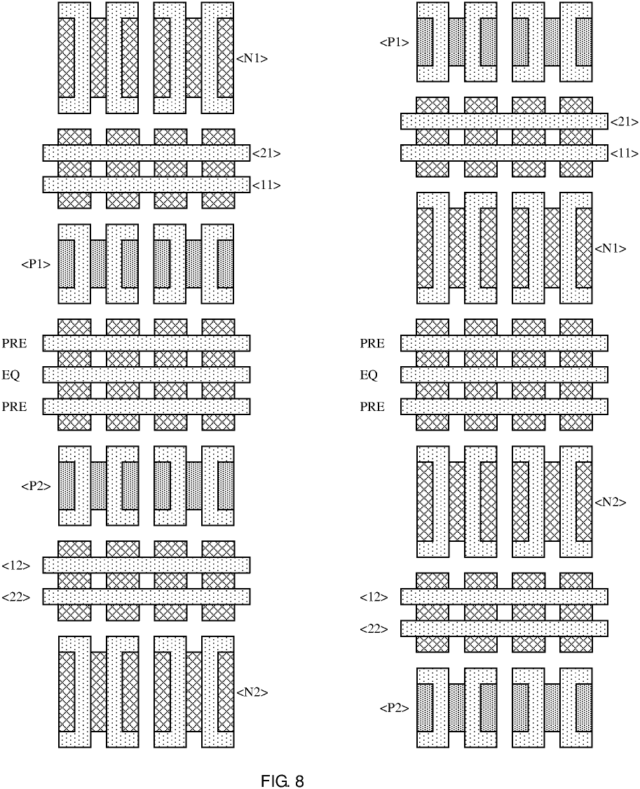

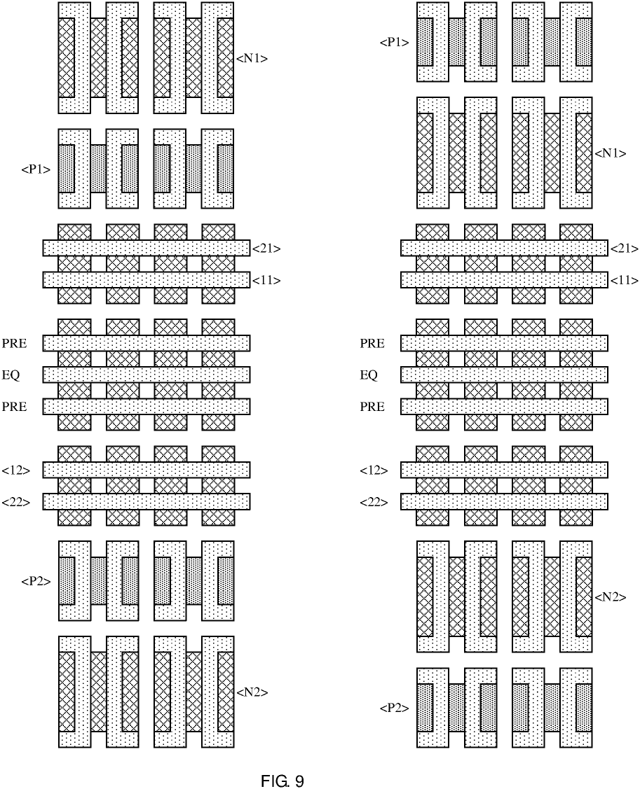

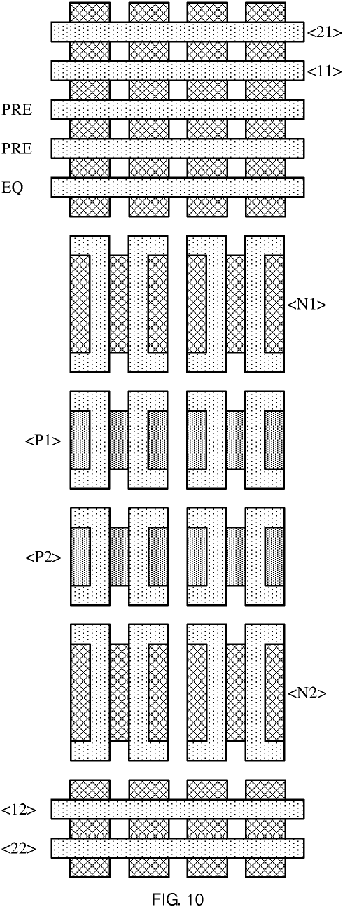

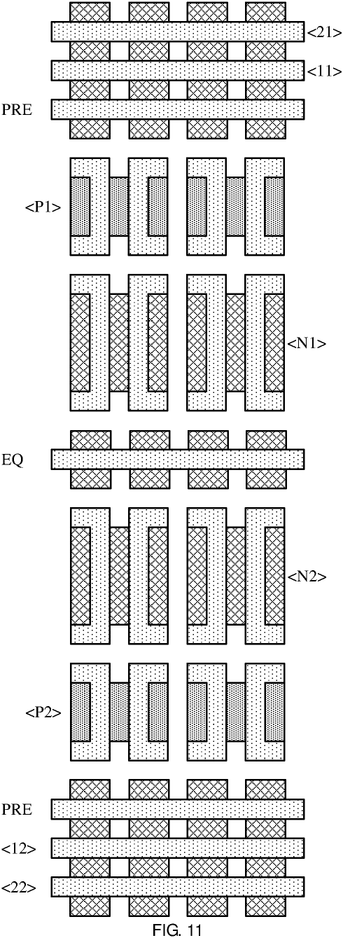

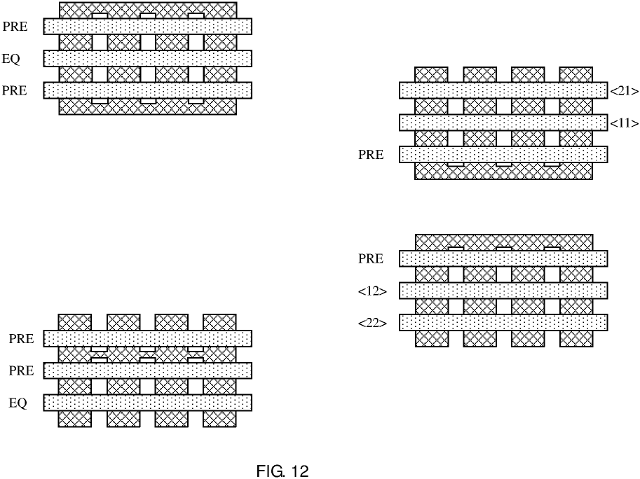

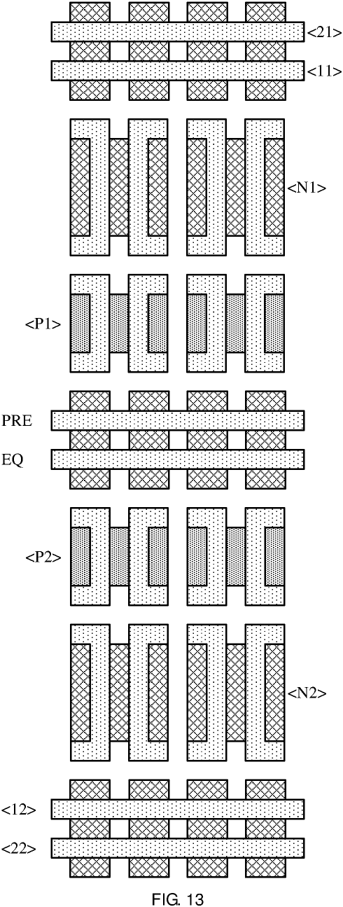

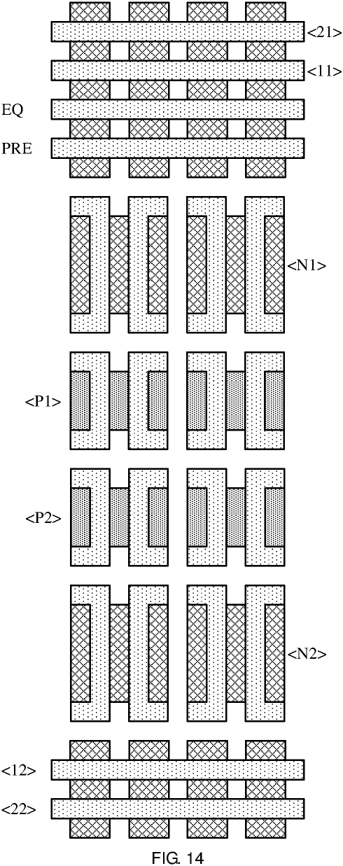

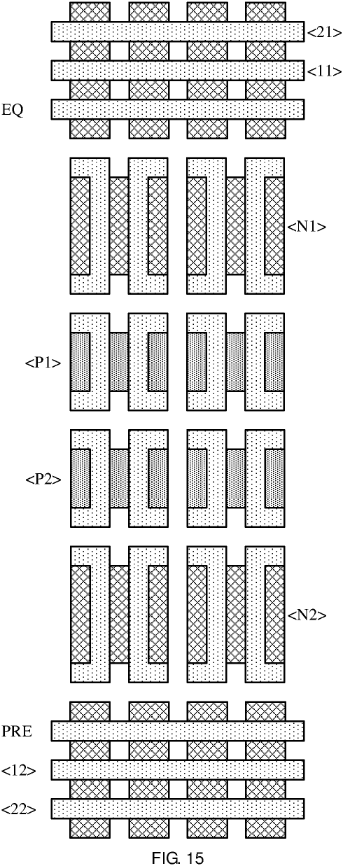

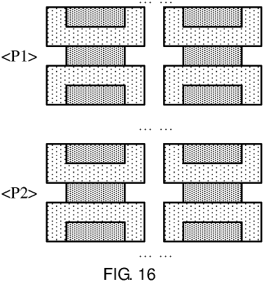

FIG. 1 is a schematic diagram of a circuit structure of a sense amplification circuit according to the present embodiment; FIG. 2 is a schematic diagram of a circuit structure of a first type of equalizing charge module according to the present embodiment; FIG. 3 is a schematic diagram of a circuit structure of a second type of equalizing charge module according to the present embodiment; FIG. 4 is a schematic diagram of a circuit structure of a third type of equalizing charge module according to the present embodiment; FIG. 5 is a schematic diagram of a circuit structure of a fourth type of equalizing charge module according to the present embodiment; FIG. 6 is a schematic diagram of a working sequence of a sense amplification circuit according to the present embodiment; FIG. 7 is a schematic diagram of a first layout corresponding to a circuit having the equalizing charge module shown in FIG. 2 or FIG. 3 according to the present embodiment; FIG. 8 is a schematic diagram of a second layout corresponding to a circuit having the equalizing charge module shown in FIG. 2 or FIG. 3 according to the present embodiment; FIG. 9 is a schematic diagram of a third layout corresponding to a circuit having the equalizing charge module shown in FIG. 2 or FIG. 3 according to the present embodiment; FIG. 10 is a schematic diagram of a fourth layout corresponding to a circuit having the equalizing charge module shown in FIG. 2 or FIG. 3 according to the present embodiment; FIG. 11 is a schematic diagram of a fifth layout corresponding to a circuit having the equalizing charge module shown in FIG. 2 or FIG. 3 according to the present embodiment; FIG. 12 is a schematic diagram of a layout in which active regions for receiving a pre-charge signal in the equalizing charge module shown in FIG. 7 to FIG. 11 are connected according to the present embodiment; FIG. 13 is a schematic diagram of a first layout corresponding to a circuit having the equalizing charge module shown in FIG. 4 or FIG. 5 according to the present embodiment; FIG. 14 is a schematic diagram of a second layout corresponding to a circuit having the equalizing charge module shown in FIG. 4 or FIG. 5 according to the present embodiment; FIG. 15 is a schematic diagram of a third layout corresponding to a circuit having the equalizing charge module shown in FIG. 4 or FIG. 5 according to the present embodiment; FIG. 16 is a schematic structural diagram of another PMOS layout according to the present embodiment. The readout circuit layout provided by this embodiment is described in further detail with reference to the accompanying drawings.

Referring to FIG. 1, the readout circuit layout includes: a first PMOS layout, a first NMOS layout, a second PMOS layout, and a second NMOS layout.

The first PMOS layout is configured to form a first PMOS transistor <P1>, where a source of the first PMOS transistor <P1> is connected to a first signal terminal (Positive Cell Storing Signal, PCS for short). Specifically, the first signal terminal PCS is configured to receive a first level signal.

The first NMOS layout is configured to form a first NMOS transistor <N1>, where a source of the first NMOS transistor <N1> is connected to a second signal terminal (Negative Cell Storing Signal, NCS for short). Specifically, the second signal terminal NCS is configured to receive a second level signal.

One of the first level signal and the second level signal is a high level signal, and the other of the first level signal and the second level signal is a low level signal.

A gate of the first PMOS transistor <P1> and a gate of the first NMOS transistor <N1> are connected to a bit line BL; a drain of the first PMOS transistor <P1> and a drain of the first NMOS transistor <N1> are connected to a complementary readout bit line SABLB.

The second PMOS layout is configured to form a second PMOS transistor <P2>, where a source of the second PMOS transistor <P2> is connected to the first signal terminal PCS.

The second NMOS layout is configured to form a second NMOS transistor <N2>, where a source of the second NMOS transistor <N2> is connected to the second signal terminal NCS.

A gate of the second PMOS transistor <P2> and a gate of the second NMOS transistor <N2> are connected to a complementary bit line BLB; a drain of the second PMOS transistor <P2> and a drain of the second NMOS transistor <N2> are connected to a readout bit line SABL.

In a direction perpendicular to an extension direction of the bit line, the first PMOS layout and the second PMOS layout are symmetrical to each other, and the first NMOS layout and the second NMOS layout are symmetrical to each other.

The gate of the first PMOS transistor and the gate of the first NMOS transistor are directly connected to the bit line; the gate of the second PMOS transistor and the gate of the second NMOS transistor are directly connected to the complementary bit line. Through the same gate connection relationship, the first PMOS transistor and the first NMOS transistor implement potential amplification of the bit line; through the same gate connection relationship, the second PMOS transistor and the second NMOS transistor implement potential amplification of the complementary bit line, thereby improving the readout accuracy of the sense amplifier.

It should be noted that, the sense amplification circuit provided by the present disclosure is described in detail below by using an example in which the first level signal is a high level corresponding to logic “1”, and the second level signal is a low level corresponding to logic “0”, which does not limit this embodiment. In some embodiments, the first level signal may be a low level corresponding to logic “0”, and the second level signal may be a high level corresponding to logic “1”. In this case, the sense amplifier is used for inverse amplification of bit line data, and original data can be outputted through inversion in the subsequent transmission process.

In some embodiments, the readout circuit layout further includes an offset cancellation layout and an isolation layout. The offset cancellation layout is used for forming a first offset cancellation MOS transistor <21> and a second offset cancellation MOS transistor <22>. The isolation layout is used for forming a first isolation MOS transistor <11> and a second isolation MOS transistor <12>. The first offset cancellation MOS transistor <21> and the first isolation MOS transistor <11> are provided in a first region; the first offset cancellation MOS transistor <21> and the first isolation MOS transistor <11> share an active region. The second offset cancellation MOS transistor <22> and the second isolation MOS transistor <12> are provided in a second region; the second offset cancellation MOS transistor <22> and the second isolation MOS transistor <12> share an active region. In a direction perpendicular to an extension direction of the bit line, the first region and the second region are symmetrical to each other.

Specifically, referring to FIG. 1, an offset cancellation module 201 includes a first offset cancellation MOS transistor <21> and a second offset cancellation MOS transistor <22>. A source of the first offset cancellation MOS transistor <21> is connected to the bit line BL, a drain of the first offset cancellation MOS transistor <21> is connected to the complementary readout bit line SABLB, and a gate of the first offset cancellation MOS transistor <21> is configured to receive an offset cancellation signal OC. A source of the second offset cancellation MOS transistor <22> is connected to the complementary bit line BLB, a drain of the second offset cancellation MOS transistor <22> is connected to the readout bit line SABL, and a gate of the second offset cancellation MOS transistor <22> is configured to receive the offset cancellation signal OC.

Specifically, referring to FIG. 1, an isolation module 301 includes a first isolation MOS transistor <11> and a second isolation MOS transistor <12>. A source of the first isolation MOS transistor <11> is connected to the bit line BL, a drain of the first isolation MOS transistor <11> is connected to the readout bit line SABL, and a gate of the first isolation MOS transistor <11> is configured to receive an isolation signal ISO. A source of the second isolation MOS transistor <12> is connected to the complementary bit line BLB, a drain of the second isolation MOS transistor <12> is connected to the complementary readout bit line SABLB, and a gate of the second isolation MOS transistor <12> is configured to receive the isolation signal ISO.

It should be noted that, the specific connection manner of the “source” and “drain” of each transistor above does not limit this embodiment. In other embodiments, a connection manner in which the “source” is replaced with the “drain”, and the “drain” is replaced with the “source” may be used.

In the readout circuit layout provided by the present disclosure, the gate of the first PMOS transistor <P1> and the gate of the first NMOS transistor <N1> are directly connected to the bit line BL. A bias voltage after offset cancellation first appears on the complementary readout bit line SABLB. That is, the bias voltage does not affect the stability of offset cancellation of the first PMOS transistor <P1> and the first NMOS transistor <N1>. When the bias voltage is synchronized to the bit line BL, the offset cancellation process has been completed. That is, the gate of the first PMOS transistor <P1> and the gate of the first NMOS transistor <N1> are directly controlled through the bit line BL, which further improves the stability of the offset cancellation of the sense amplification circuit. Similarly, the gate of the second PMOS transistor <P2> and the gate of the second NMOS transistor <N2> are directly connected to the complementary bit line BLB. A bias voltage after offset cancellation first appears on the readout bit line SABL. That is, the bias voltage does not affect the stability of offset cancellation of the second PMOS transistor <P2> and the second NMOS transistor <N2>. When the bias voltage is synchronized to the complementary bit line BLB, the offset cancellation process has been completed. That is, the gate of the second PMOS transistor <P2> and the gate of the second NMOS transistor <N2> are directly controlled by the complementary bit line BLB, which further improve the stability of the offset cancellation of the sense amplification circuit.

In some embodiments, the readout circuit layout further includes: an equalizing charge layout, configured to form an equalizing charge module. The equalizing charge layout is partially provided in a first region and partially provided in a second region; or the first PMOS layout and the second PMOS layout are symmetrical to each other based on the equalizing charge layout, the first NMOS layout and the second NMOS layout are symmetrical to each other based on the equalizing charge layout, and the first region and the second region are symmetrical to each other based on the equalizing charge layout.

Specifically, referring to FIG. 1, one terminal of the equalizing charge module 101 is connected to the readout bit line SABL and the other terminal of the equalizing charge module 101 is connected to the complementary readout bit line SABLB, and the equalizing charge module 101 is configured to equalize the readout bit line SABL and the complementary readout bit line SABLB to a preset voltage VBLP.

In an example, referring to FIG. 2, the equalizing charge module 101 includes a first pre-charge MOS transistor, a second pre-charge MOS transistor, and an equalizing MOS transistor. A source of the first pre-charge MOS transistor is connected to the complementary readout bit line SABLB; a source of the second pre-charge MOS transistor is connected to the readout bit line SABL; a drain of the first pre-charge MOS transistor and a drain of the second pre-charge MOS transistor are configured to receive a preset voltage VBLP; a gate of the first pre-charge MOS transistor and a gate of the second pre-charge MOS transistor are configured to receive a pre-charge signal (PRE); a source of the equalizing MOS transistor is connected to the complementary readout bit line SABLB, a drain of the equalizing MOS transistor is connected to the readout bit line SABL, and a gate of the equalizing MOS transistor is configured to receive an equalizing signal (EQ).

In an example, referring to FIG. 3, the equalizing charge module 101 includes a first pre-charge MOS transistor, a second pre-charge MOS transistor, and an equalizing MOS transistor. A source of the first pre-charge MOS transistor is connected to the complementary readout bit line SABLB; a source of the second pre-charge MOS transistor is connected to the readout bit line SABL; a drain of the first pre-charge MOS transistor and a drain of the second pre-charge MOS transistor are configured to receive a preset voltage VBLP; a source of the equalizing MOS transistor is connected to the complementary readout bit line SABLB, and a drain of the equalizing MOS transistor is connected to the readout bit line SABL; a gate of the first pre-charge MOS transistor, a gate of the second pre-charge MOS transistor, and a gate of the equalizing MOS transistor are configured to receive the equalizing signal EQ.

Referring to FIG. 7 to FIG. 11, in some embodiments, the equalizing charge layout is configured to form a first pre-charge MOS transistor, a second pre-charge MOS transistor, and an equalizing MOS transistor. An extension direction of a gate of the first pre-charge MOS transistor, an extension direction of a gate of the second pre-charge MOS transistor, and an extension direction of a gate of the equalizing MOS transistor are the same; the first pre-charge MOS transistor, the second pre-charge MOS transistor, and the equalizing MOS transistor share an active region.

A layout of a sense amplification circuit having the equalizing charge module shown in FIG. 2 and FIG. 3 is as follows:

In an example, specifically referring to FIG. 7, the equalizing charge layout is provided at a middle position. The first PMOS layout and the second PMOS layout are symmetrical to each other based on the equalizing charge layout; the first NMOS layout and the second NMOS layout are symmetrical to each other based on the equalizing charge layout; the first region and the second region are symmetrical to each other based on the equalizing charge layout. The first region is provided at a side of the first PMOS layout and the first NMOS layout which is away from the equalizing charge layout; the second region is provided at a side of the second PMOS layout and the second NMOS layout which is away from the equalizing charge layout. It should be noted that, in this example, positions of the first PMOS layout and the first NMOS layout are interchangeable; accordingly, positions of the second PMOS layout and the second NMOS layout are interchangeable.

In an example, specifically referring to FIG. 8, the equalizing charge layout is provided at a middle position. The first PMOS layout and the second PMOS layout are symmetrical to each other based on the equalizing charge layout; the first NMOS layout and the second NMOS layout are symmetrical to each other based on the equalizing charge layout; the first region and the second region are symmetrical to each other based on the equalizing charge layout. The first region is provided between the first PMOS layout and the first NMOS layout; the second region is provided between the second PMOS layout and the second NMOS layout. It should be noted that, in this example, positions of the first PMOS layout and the first NMOS layout are interchangeable; accordingly, positions of the second PMOS layout and the second NMOS layout are interchangeable.

In an example, specifically referring to FIG. 9, the equalizing charge layout is provided at a middle position. The first PMOS layout and the second PMOS layout are symmetrical to each other based on the equalizing charge layout; the first NMOS layout and the second NMOS layout are symmetrical to each other based on the equalizing charge layout; the first region and the second region are symmetrical to each other based on the equalizing charge layout. The first region is provided at a side of the first PMOS layout and the first NMOS layout which is close to the equalizing charge layout; the second region is provided at a side of the second PMOS layout and the second NMOS layout which is close to the equalizing charge layout. It should be noted that, in this example, positions of the first PMOS layout and the first NMOS layout are interchangeable; accordingly, positions of the second PMOS layout and the second NMOS layout are interchangeable.

In an example, referring to FIG. 10, the first PMOS layout and the second PMOS layout are symmetrical to each other; the first NMOS layout and the second NMOS layout are symmetrical to each other; the first region and the second region are symmetrical to each other. The equalizing charge layout is provided in the first region. It should be noted that, in this example, positions of the first PMOS layout and the first NMOS layout are interchangeable; the equalizing charge layout may alternatively be provided in the second region. In addition, the structure shown in FIG. 10 is also applicable to transformation from FIG. 7 to FIG. 8 and from FIG. 7 to FIG. 9.

In an example, referring to FIG. 11, in the equalizing charge layout, the first pre-charge MOS transistor is arranged in the first region, the second pre-charge MOS transistor is arranged in the second region, and the equalizing MOS transistor is arranged at a middle position. The first PMOS layout and the second PMOS layout are symmetrical to each other based on the equalizing MOS transistor; the first NMOS layout and the second NMOS layout are symmetrical to each other based on the equalizing MOS transistor; the first region and the second region are symmetrical to each other based on the equalizing MOS transistor. The first region is provided at a side of the first PMOS layout and the first NMOS layout which is close to the equalizing charge layout; the second region is provided at a side of the second PMOS layout and the second NMOS layout which is close to the equalizing charge layout. It should be noted that, in this example, positions of the first PMOS layout and the first NMOS layout are interchangeable; accordingly, positions of the second PMOS layout and the second NMOS layout are interchangeable. In addition, the structure shown in FIG. 11 is also applicable to transformation from FIG. 7 to FIG. 8 and from FIG. 7 to FIG. 9.

Referring to FIG. 7 to FIG. 11 in conjunction with FIG. 12 (the upper left part of FIG. 12 corresponds to the layout shown in FIG. 7 to FIG. 9; the lower left part of FIG. 12 corresponds to the layout shown in FIG. 10; the right part of FIG. 12 corresponds to the layout shown in FIG. 11). In some embodiments, active regions for receiving the pre-charge signal are interconnected, to simplify layout connection lines when the pre-charge signal is received subsequently, and increase the driving capability of the active regions for receiving the pre-charge signal.

In an example, referring to FIG. 4, the equalizing charge module 101 includes a pre-charge MOS transistor and an equalizing MOS transistor. A source of the pre-charge MOS transistor is connected to the complementary readout bit line SABLB or the readout bit line SABL, a drain of the pre-charge MOS transistor is configured to receive the preset voltage, and a gate of the pre-charge MOS transistor is configured to receive the pre-charge signal PRE. A source of the equalizing MOS transistor is connected to the complementary readout bit line SABLB, a drain of the equalizing MOS transistor is connected to the readout bit line SABL, and a gate of the equalizing MOS transistor is configured to receive the equalizing signal EQ.

In an example, referring to FIG. 5, the equalizing charge module 101 includes a pre-charge MOS transistor and an equalizing MOS transistor. A source of the pre-charge MOS transistor is connected to the complementary readout bit line SABLB or the readout bit line SABL, and a drain of the pre-charge MOS transistor is configured to receive the preset voltage. A source of the equalizing MOS transistor is connected to the complementary readout bit line SABLB, and a drain of the equalizing MOS transistor is connected to the readout bit line SABL. A gate of the pre-charge MOS transistor and a gate of the equalizing MOS transistor are configured to receive the equalizing signal EQ.

Referring to FIG. 13 to FIG. 15, in some embodiments, the equalizing charge layout is configured to form a pre-charge MOS transistor and an equalizing MOS transistor. An extension direction of a gate of the pre-charge MOS transistor and an extension direction of a gate of the equalizing MOS transistor are the same; the pre-charge MOS transistor and the equalizing MOS transistor share an active region.

A layout of a sense amplification circuit having the equalizing charge module shown in FIG. 4 and FIG. 5 is as follows:

In an example, specifically referring to FIG. 13, the equalizing charge layout is provided at a middle position. The first PMOS layout and the second PMOS layout are symmetrical to each other based on the equalizing charge layout; the first NMOS layout and the second NMOS layout are symmetrical to each other based on the equalizing charge layout; the first region and the second region are symmetrical to each other based on the equalizing charge layout. The first region is provided at a side of the first PMOS layout and the first NMOS layout which is away from the equalizing charge layout; the second region is provided at a side of the second PMOS layout and the second NMOS layout which is away from the equalizing charge layout. It should be noted that, in this example, positions of the first PMOS layout and the first NMOS layout are interchangeable; accordingly, positions of the second PMOS layout and the second NMOS layout are interchangeable. In addition, the structure shown in FIG. 13 is also applicable to transformation from FIG. 7 to FIG. 8 and from FIG. 7 to FIG. 9.

In an example, specifically referring to FIG. 14, the first PMOS layout and the second PMOS layout are symmetrical to each other; the first NMOS layout and the second NMOS layout are symmetrical to each other; the first region and the second region are symmetrical to each other. The equalizing charge layout is provided in the first region. It should be noted that, in this example, positions of the first PMOS layout and the first NMOS layout are interchangeable; the equalizing charge layout may alternatively be provided in the second region. In addition, the structure shown in FIG. 10 is also applicable to transformation from FIG. 7 to FIG. 8 and from FIG. 7 to FIG. 9.

In an example, specifically referring to FIG. 15, in the equalizing charge layout, the pre-charge MOS transistor is provided in the first region, and the equalizing MOS transistor are provided in the second region. The first PMOS layout and the second PMOS layout are symmetrical to each other; the first NMOS layout and the second NMOS layout are symmetrical to each other; the first region and the second region are symmetrical to each other. It should be noted that, in this example, positions of the first PMOS layout and the first NMOS layout are interchangeable; the equalizing charge layout may alternatively be provided in the second region. In addition, the structure shown in FIG. 10 is also applicable to transformation from FIG. 7 to FIG. 8 and from FIG. 7 to FIG. 9.

It should be noted that, in the schematic diagrams in FIG. 13 to FIG. 15, active regions for receiving the pre-charge signal are interconnected, to simplify layout connection lines when the pre-charge signal is received subsequently, and increase the driving capability of the active regions for receiving the pre-charge signal.

In the circuit shown in FIG. 7 to FIG. 15, an extension direction of a gate of the first PMOS layout, an extension direction of a gate of the second PMOS layout, an extension direction of a gate of the first NMOS layout, and an extension direction of a gate of the second NMOS layout are the same, and an extension direction of the gate of the first PMOS layout intersects with an extension direction of a gate of the equalizing MOS layout.

In some embodiments, referring to FIG. 16 in conjunction with FIG. 7 to FIG. 15, an extension direction of the gate of the first NMOS layout and an extension direction of the gate of the second NMOS layout are the same; an extension direction of the gate of the first PMOS layout, an extension direction of the gate of the second PMOS layout, and an extension direction of the gate of the equalizing charge layout are the same; an extension direction of the gate of the first NMOS layout intersects with an extension direction of a gate of the equalizing MOS charge layout.

In this embodiment, the preset voltage VBLP=½VDD, where VDD is a power voltage inside a chip. In other embodiments, the preset voltage VBLP may be set according to specific application scenarios.

Semiconductor devices forming a readout amplifier may have different device characteristics (e.g., threshold voltage) due to factors such as a process change and temperature. Different device characteristics may cause an offset noise in the readout amplifier, while the offset noise reduces the effective readout margin of the readout amplifier and reduces the performance of the DRAM.

An amplification process of the sense amplification circuit in the present disclosure includes 4 stages. Referring to FIG. 6, in a first phase S1 (t0 to t1), an equalizing signal EQ, a pre-charge signal PRE, an isolation signal ISO, and an offset cancellation signal OC are provided, to associate all lines in the sense amplification circuit, and all the lines are pre-charged to a preset voltage. In the second phase S2 (t1 to t2), the offset cancellation signal OC is provided continuously; a first voltage is provided to the first signal terminal PCS, and a second voltage is provided to the second signal terminal NCS; an offset voltage formed by an amplified difference between the first NMOS transistor <N1> and the second NMOS transistor <N2> and an amplified difference between the first PMOS transistor <P1> and the second PMOS transistor <P2> is transferred to the readout bit line SABL and the complementary readout bit line SABLB; electric potentials of the readout bit line SABL and the complementary readout bit line SABLB is set to a difference having the offset voltage; meanwhile, the first offset cancellation MOS transistor <21> and the second offset cancellation MOS transistor <22>, both having the offset cancellation signal OC, are turned on; the readout bit line SABL is connected to the complementary bit line BLB, and the complementary readout bit line SABLB is connected to the bit line BL; electric potentials of the bit line BL and the complementary bit line BLB are also set to a difference having the offset voltage. Therefore, the offset noise of the sense amplification circuit is eliminated. In the second phase S2 (t2 to t3), signals received by the first signal terminal PCS and the second signal terminal NCS are restored to the preset voltage. It should be noted that, in some embodiments, in the second phase S2 (t2 to t3), after the signals received by the first signal terminal PCS and the second signal terminal NCS are restored to the preset voltage, the equalizing signal EQ is further provided, to equalize the electric potentials of the readout bit line SABL and the complementary readout bit line SABLB to the preset voltage, so as to reduce errors in subsequent signal amplification. In the second phase S2 (t3 to t4), the isolation signal ISO is provided; the bit line BL and the readout bit line SABL perform charge sharing, or the complementary bit line BLB is electrically connected to the complementary readout bit line SABLB to perform charge sharing, so that an electric potential of a turned-on memory cell is synchronized to the readout bit line SABL or the complementary readout bit line SABLB through a word line WL; the electric potential of the synchronized readout bit line SABL or complementary readout bit line SABLB is set to a difference having an offset voltage to implement cross synchronization of an offset potential (in the offset cancellation process, the offset voltage on the complementary readout bit line SABLB is synchronized to the bit line BL, and will be synchronized to the readout bit line SABL in this phase), so as to compensate for the amplified difference between the first NMOS transistor <N1> and the second NMOS transistor <N2>, and compensate for the amplified difference between the first PMOS transistor <P1> and the second PMOS transistor <P2>. In phase S3 (t4 to t5), i.e., a signal readout phase, after the sense amplification circuit performs sense amplification according to the electric potentials of the readout bit line SABL and the complementary readout bit line SABLB, stored data is read out, and data restoration is performed on the electric potential of the memory cell. In phase S4 (t5 to t6), i.e., signal restoration phase, electric potentials of various lines in the readout circuit are pre-charged to the preset voltage, to prepare for the next data readout.

The gate of the first PMOS transistor <P1> and the gate of the first NMOS transistor <N1> are directly connected to the bit line BL; the gate of the second PMOS transistor <P2> and the gate of the second NMOS transistor <N2> are directly connected to the complementary bit line BLB. Through the same gate connection relationship, the first PMOS transistor <P1> and the first NMOS transistor <N1> implement potential amplification of the bit line BL; through the same gate connection relationship, the second PMOS transistor <P2> and the second NMOS transistor <N2> implement potential amplification of the complementary bit line BLB, thereby improving the readout accuracy of the sense amplifier.

It should be noted that, in order to highlight the innovative part of the present disclosure, units that are not closely related to resolving the technical problem proposed by the present disclosure are not introduced in this embodiment, but this does not indicate that there are no other units in this embodiment.

Those skilled in the art can understand that the above embodiments are specific embodiments for implementing the present disclosure. In practical applications, various changes may be made to the above embodiments in terms of forms and details without departing from the spirit and scope of the present disclosure.

1. A readout circuit layout, comprising:
a first p-type metal oxide semiconductor (PMOS) layout, configured to form a first PMOS transistor, wherein a source of the first PMOS transistor is connected to a first signal terminal, and the first signal terminal is configured to receive a first level signal;
a first n-type metal oxide semiconductor (NMOS) layout, configured to form a first NMOS transistor, wherein a source of the first NMOS transistor is connected to a second signal terminal, and the second signal terminal is configured to receive a second level signal;
wherein one of the first level signal and the second level signal is a high level signal, and the other of the first level signal and the second level signal is a low level signal;
a gate of the first PMOS transistor and a gate of the first NMOS transistor are connected to a bit line, and a drain of the first PMOS transistor and a drain of the first NMOS transistor are connected to a complementary readout bit line;
a second PMOS layout, configured to form a second PMOS transistor, wherein a source of the second PMOS transistor is connected to the first signal terminal;
a second NMOS layout, configured to form a second NMOS transistor, wherein a source of the second NMOS transistor is connected to the second signal terminal;
wherein a gate of the second PMOS transistor and a gate of the second NMOS transistor are connected to a complementary bit line, and a drain of the second PMOS transistor and a drain of the second NMOS transistor are connected to a readout bit line; and
in a direction perpendicular to an extension direction of the bit line, the first PMOS layout and the second PMOS layout are symmetrical to each other, and the first NMOS layout and the second NMOS layout are symmetrical to each other; and
an equalizing charge layout, configured to form an equalizing charge module;
wherein the equalizing charge module comprises:
a first pre-charge metal oxide semiconductor (MOS) transistor, a source of the first pre-charge MOS transistor being connected to the complementary readout bit line;
a second pre-charge MOS transistor, a source of the second pre-charge MOS transistor being connected to the readout bit line;
wherein a drain of the first pre-charge MOS transistor and a drain of the second pre-charge MOS transistor are configured to receive a preset voltage, and a gate of the first pre-charge MOS transistor and a gate of the second pre-charge MOS transistor are configured to receive a pre-charge signal; and
an equalizing MOS transistor, wherein a source of the equalizing MOS transistor is connected to the complementary readout bit line, a drain of the equalizing MOS transistor is connected to the readout bit line, and a gate of the equalizing MOS transistor is configured to receive an equalizing signal;
wherein the pre-charge signal and the equalizing signal are different signals; and
in the equalizing charge layout, active regions for receiving the pre-charge signal are interconnected.

2. The readout circuit layout according to claim 1, further comprising:
an offset cancellation layout, configured to form a first offset cancellation MOS transistor and a second offset cancellation MOS transistor; and
an isolation layout, configured to form a first isolation MOS transistor and a second isolation MOS transistor;
wherein the first offset cancellation MOS transistor and the first isolation MOS transistor are provided in a first region, and the first offset cancellation MOS transistor and the first isolation MOS transistor share an active region;
the second offset cancellation MOS transistor and the second isolation MOS transistor are provided in a second region, and the second offset cancellation MOS transistor and the second isolation MOS transistor share a second active region; and
in the direction perpendicular to the extension direction of the bit line, the first region and the second region are symmetrical to each other.

3. The readout circuit layout according to claim 2, wherein a source of the first offset cancellation MOS transistor is connected to the bit line, a drain of the first offset cancellation MOS transistor is connected to the complementary readout bit line, and a gate of the first offset cancellation MOS transistor is configured to receive an offset cancellation signal; and a source of the second offset cancellation MOS transistor is connected to the complementary bit line, a drain of the second offset cancellation MOS transistor is connected to the readout bit line, and a gate of the second offset cancellation MOS transistor is configured to receive the offset cancellation signal.

4. The readout circuit layout according to claim 2, wherein a source of the first isolation MOS transistor is connected to the bit line, a drain of the first isolation MOS transistor is connected to the readout bit line, and a gate of the first isolation MOS transistor is configured to receive an isolation signal; and a source of the second isolation MOS transistor is connected to the complementary bit line, a drain of the second isolation MOS transistor is connected to the complementary readout bit line, and a gate of the second isolation MOS transistor is configured to receive the isolation signal.

5. The readout circuit layout according to claim 1, wherein
the equalizing charge layout is partially provided in a first region and partially provided in a second region; or
the first PMOS layout and the second PMOS layout are symmetrical to each other based on the equalizing charge layout, the first NMOS layout and the second NMOS layout are symmetrical to each other based on the equalizing charge layout, and the first region and the second region are symmetrical to each other based on the equalizing charge layout.

6. The readout circuit layout according to claim 5, wherein one terminal of the equalizing charge module is connected to the readout bit line, and another terminal of the equalizing charge module is connected to the complementary readout bit line, and the equalizing charge module is configured to equalize the readout bit line and the complementary readout bit line to the preset voltage.

7. (canceled)

8. (canceled)

9. The readout circuit layout according to claim 6, wherein the equalizing charge layout is configured to form the first pre-charge MOS transistor, the second pre-charge MOS transistor and the equalizing MOS transistor;
an extension direction of the gate of the first pre-charge MOS transistor, an extension direction of the gate of the second pre-charge MOS transistor, and an extension direction of the gate of the equalizing MOS transistor are the same; and
the first pre-charge MOS transistor, the second pre-charge MOS transistor, and the equalizing MOS transistor share an active region.

10-12. (canceled)

13. The readout circuit layout according to claim 6, wherein an extension direction of a gate of the first PMOS layout, an extension direction of a gate of the second PMOS layout, an extension direction of a gate of the first NMOS layout, and an extension direction of a gate of the second NMOS layout are the same, and the extension direction of the gate of the first PMOS layout intersects with an extension direction of a gate of an equalizing MOS layout.

14. The readout circuit layout according to claim 6, wherein an extension direction of a gate of the first NMOS layout and an extension direction of a gate of the second NMOS layout are the same; an extension direction of a gate of the first PMOS layout, an extension direction of a gate of the second PMOS layout, and an extension direction of a gate of the equalizing charge layout are the same; and the extension direction of the gate of the first NMOS layout intersects with an extension direction of a gate of an equalizing MOS charge layout.

15-17. (canceled)
